(19) United States
(12) Patent Application Publication
(10) Pub. No.: US 2025/0013494 A1
(43) Pub. Date: Jan. 9, 2025

(54) THREAD MANAGEMENT METHODS AND APPARATUSES

(71) Applicant: Beijing OceanBase Technology Co., Ltd., Beijing (CN)

(72) Inventor: Huafeng Xi, Beijing (CN)

(73) Assignee: Beijing OceanBase Technology Co., Ltd., Beijing (CN)

(21) Appl. No.: 18/890,369

(22) Filed: Sep. 19, 2024

Related U.S. Application Data
(63) Continuation of application No. PCT/CN2023/095208, filed on May 19, 2023.

(30) Foreign Application Priority Data
Jun. 17, 2022 (CN) 202210690077.0

(51) Int. Cl. G06F 9/48

(52) U.S. Cl. CPC G06F 9/4881; G06F 9/4812; G06F 2209/486

(57) ABSTRACT

A computer-implemented method for thread management includes creating a first thread, where the first thread is a kernel-level thread and the first thread has a first thread context. A second thread is created through the first thread, where the second thread is a user-level thread and the second thread inherits the first thread context. After the second thread is stored in a run queue, the first thread is controller to enter an idle loop state. The second thread is selected from the run queue through a scheduling thread. The second thread is executed.

### CROSS-REFERENCE TO RELATED APPLICATIONS

This application is a continuation of PCT Application No. PCT/CN2023/095208, filed on May 19, 2023, which claims priority to Chinese Patent Application No. 202210690077.0, filed on Jun. 17, 2022, and each application is hereby incorporated by reference in its entirety.

### TECHNICAL FIELD

This disclosure relates to the field of computer technologies, and in particular, to thread management methods and apparatuses.

### BACKGROUND

Compared with a kernel-level thread, a user-level thread has advantages of a customizable dedicated scheduling policy and low thread switching costs. Therefore, the user-level thread can satisfy special scheduling needs of users and can improve system performance.

Currently, the user-level thread is mainly implemented by a coroutine. However, compared with a standard kernel-level thread, the coroutine lacks some functions. Consequently, there is poor compatibility between the user-level thread and the kernel-level thread.

### SUMMARY

In view of this, one or more embodiments of this disclosure are dedicated to providing thread management methods and apparatuses, to improve compatibility of a user-level thread.

According to a first aspect, a thread management method is provided, and includes: creating a first thread, where the first thread is a kernel-level thread, and the first thread has a first thread context; creating a second thread through the first thread, where the second thread is a user-level thread, and the second thread inherits the first thread context; after the second thread is stored in a run queue, controlling the first thread to enter an idle loop state; and selecting the second thread from the run queue through a scheduling thread, and executing the second thread.

Optionally, in some possible implementations, the method further includes: receiving a first signal through the scheduling thread; in response to the first signal, controlling, through the scheduling thread, the second thread to stop being executed; and re-storing the second thread in the run queue.

Optionally, in some possible implementations, the first signal is triggered by a timer.

Optionally, in some possible implementations, the method further includes: receiving a second signal through the first thread; in response to the second signal, marking the second thread to be in a signal interrupt state; and processing the second signal through a signal processing thread.

Optionally, in some possible implementations, after the marking the second thread to be in a signal interrupt state, the method further includes: determining whether the second thread is in an execution state; and interrupting execution of the second thread if the second thread is in the execution state.

Optionally, in some possible implementations, the first thread context includes a thread-local variable of the first thread.

According to a second aspect, a thread management apparatus is provided, and includes: a first creation unit, configured to create a first thread, where the first thread is a kernel-level thread, and the first thread has a first thread context; a second creation unit, configured to create a second thread through the first thread, where the second thread is a user-level thread, and the second thread inherits the first thread context; a first control unit, configured to: after the second thread is stored in a run queue, control the first thread to enter an idle loop state; and an execution unit, configured to: select the second thread from the run queue through a scheduling thread, and execute the second thread.

Optionally, in some possible implementations, the apparatus further includes: a first receiving unit, configured to receive a first signal through the scheduling thread; a second control unit, configured to: in response to the first signal, control, through the scheduling thread, the second thread to stop being executed; and a storage unit, configured to re-store the second thread in the run queue.

Optionally, in some possible implementations, the first signal is triggered by a timer.

Optionally, in some possible implementations, the apparatus further includes: a second receiving unit, configured to receive a second signal through the first thread; a marking unit, configured to: in response to the second signal, mark the second thread to be in a signal interrupt state; and a processing unit, configured to process the second signal through a signal processing thread.

Optionally, in some possible implementations, after the marking the second thread to be in a signal interrupt state, the apparatus further includes: a determining unit, configured to determine whether the second thread is in an execution state; and an interrupt unit, configured to interrupt execution of the second thread if the second thread is in the execution state.

Optionally, in some possible implementations, the first thread context includes a thread-local variable of the first thread.

According to a third aspect, a thread management apparatus is provided, and includes: a storage, configured to store instructions; and a processor, configured to execute the instructions stored in the storage, to perform the method according to any one of the first aspect or the possible implementations of the first aspect.

According to a fourth aspect, a computer-readable storage medium is provided. The computer-readable storage medium stores instructions used to perform the method according to any one of the first aspect or the possible implementations of the first aspect.

According to a fifth aspect, a computer program product is provided, and includes instructions used to perform the method according to any one of the first aspect or the possible implementations of the first aspect.

A thread context usually includes various types of information such as various register states and thread stacks of a thread. In the one or more embodiments of this disclosure, the second thread (namely, the user-level thread) inherits the thread context of the first thread (namely, the kernel-level thread), so that the second thread also has various functions of the kernel-level thread, to improve compatibility between the user-level thread and the kernel-level thread.

### BRIEF DESCRIPTION OF DRAWINGS

FIG. 1 is a schematic diagram illustrating a process in which a user program executes a system call;

FIG. 2 is a schematic flowchart illustrating a thread management method, according to one or more embodiments of this disclosure;

FIG. 3 is a schematic diagram illustrating a relationship between a first thread and a second thread, according to one or more embodiments of this disclosure;

FIG. 4 is a schematic flowchart illustrating that a first thread enters an idle loop state, according to one or more embodiments of this disclosure;

FIG. 5 is a schematic diagram illustrating a subsequent operation procedure of a first thread and a second thread after running of the second thread ends, according to one or more embodiments of this disclosure;

FIG. 6 is a schematic diagram illustrating preemptive scheduling of a thread, according to one or more embodiments of this disclosure;

FIG. 7 is a schematic structural diagram illustrating a thread management apparatus, according to one or more embodiments of this disclosure; and

FIG. 8 is a schematic structural diagram illustrating a thread management apparatus, according to one or more other embodiments of this disclosure.

### DESCRIPTION OF EMBODIMENTS

The following clearly and comprehensively describes technical solutions in embodiments of this disclosure with reference to accompanying drawings in the embodiments of this disclosure. Clearly, described embodiments are merely some rather than all of embodiments of this disclosure.

For ease of understanding, basic concepts in the embodiments of this disclosure are first explained.

### Operating System

The operating system (OS) is a computer program that manages computer hardware and software resources. The operating system needs to process basic services such as managing and configuring memory, determining priorities of system resource supply and demand, controlling an input device and an output device, and operating a network and managing a file system.

### Computer Program

The computer program, also referred to as software or a program, is a group of instructions that instruct a computer or an apparatus with an information processing capability to perform an action or perform determining. The program is usually written in a specific program design language and runs on a specific target computer system structure.

### Process

The process is a running activity of a program in a computer on a specific data set, is a basic unit in which a system performs resource allocation and scheduling, and is a basis of an operating system structure. In an early process-oriented computer structure, the process is a basic execution entity of the program. In a contemporary thread-oriented computer structure, the process is a container of a thread. The program is a description of instructions, data, and an organization form of the instructions and data, and the process is an entity of the program.

The thread is a smallest unit in which an operating system can perform operation and scheduling, can be included in a process, and is an actual operating unit in the process. One thread is one control flow in a single sequence in the process. A plurality of threads can be concurrent in one process, and all threads perform different tasks in parallel.

### Thread

A core of an operating system is a kernel. The kernel is independent of a common application, has relatively high operation permission, can access a protected memory space, and can access all underlying hardware devices. To ensure system security and avoid a system crash caused by a misoperation by the application, the operating system usually prohibits a user program from directly operating the kernel. When the application needs to access the kernel (for example, the application needs to read a file on a disk), the application can access the kernel through an interface provided by the kernel for the application. The interface provided by the kernel for the application to access the kernel can be referred to as a system call interface. The system call interface can be an application programming interface (API).

To prevent the application from accessing the kernel, the operating system usually divides a virtual address that is also referred to as a virtual address space. For example, the virtual address space can be divided into a user space and a kernel space. The virtual address space can also be referred to as virtual memory, and is a manner in which the operating system performs memory management. The kernel space can only be accessed by a kernel program, and the user space can be specially used by the application or the user program. Code in the user space is limited to only one local memory space. It can be considered that the programs are executed in a user mode. Code in the kernel space can access all memory. It can be considered that these programs are executed in a kernel mode.

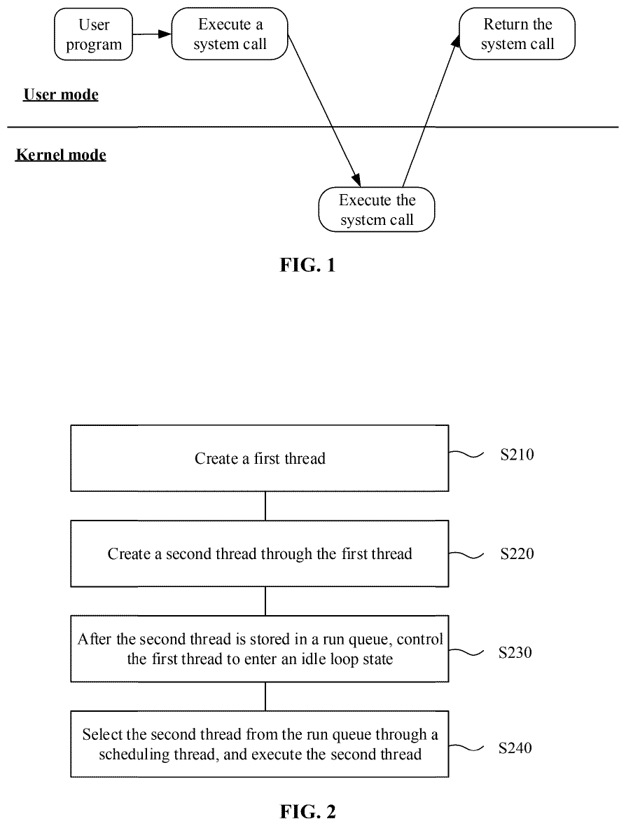

If a user-mode program needs to execute a system call, the program needs to be switched to the kernel mode for execution, as shown in FIG. 1. The kernel program is executed in the kernel mode, and a user program is executed in the user mode. When the system call occurs, the user-mode program initiates the system call. Because the system call relates to privileged instructions and the user-mode program has insufficient permission, execution is interrupted. That is, a trap occurs. After an interrupt occurs, a program currently executed by a processor is interrupted and jumps to an interrupt processing program. The kernel program starts to be executed. In other words, the system call starts to be processed. After kernel processing is completed, the trap is actively triggered. In this case, an interrupt occurs again, and switching to the user mode is performed for working.

When the application is executed, the operating system can create one or more processes for the application. The process usually represents a unit in which the operating system performs resource allocation. One process can usually correspond to one or more threads. The thread is an actual execution unit of the process.

One central processing unit (CPU) resource (for example, a core of the CPU) can be used to execute only one thread at the same moment. If a plurality of threads need to be executed, the operating system can divide the CPU resource into a plurality of timeslices, to improve processing efficiency. In one timeslice, the CPU resource can be used to execute one of a plurality of to-be-executed threads. Specifically, the operating system can maintain one run queue. A thread that has been in a runnable state is stored in the run queue. The operating system can select, for execution, one thread from the run queue based on a scheduling policy. After a timeslice of the thread is used, regardless of whether execution of the thread is completed, the operating system interrupts execution of the thread, and selects, for execution, a next thread from the run queue based on the thread scheduling policy. This process is also referred to as thread switching or context switching.

The above-mentioned thread scheduling can be understood as preferentially selecting a specific thread for running when a plurality of threads are in the runnable state. Thread scheduling can be determined based on the scheduling policy. Different implementations of the run queue correspond to different scheduling policies.

During thread switching, execution of a previous thread is not completed. A current state of the thread needs to be stored, so that when the thread is scheduled at a next time, a previous interrupt state can be continued to continue execution. The current state can be stored based on a thread context.

The thread context can be used to record a state before the thread is interrupted. The thread context can include a thread stack and a plurality of registers. The register can include one or more of the following: an instruction pointer register, a stack pointer register, and values of a plurality of segment registers. The instruction pointer register can be configured to indicate a location of a next instruction to be executed by a current thread. The stack pointer register can be configured to indicate a stack top location of a stack. The plurality of segment registers can include a first segment register, and the first segment register can be configured to store a base address of a local variable of the current thread. In other words, the thread-local variable can be accessed by using the first segment register.

In addition to the above-mentioned information, the thread context can further include a signal mask. Each thread corresponds to one signal mask. The signal mask is a “bitmap”. Each bit corresponds to one signal. If a bit in the bitmap is 0, after a signal corresponding to the bitmap is sent to the thread, a default operation on the signal is ending running of the thread. If a bit in the bitmap is 1, it indicates that a signal corresponding to a processing program component that executes a current signal is temporarily “masked”, so that the thread does not respond to a signal in a nested manner in an execution process, in other words, running of the thread does not end.

It can be seen from the above-mentioned descriptions that, provided that the thread context is restored, the thread can continue to be executed from a previously interrupted location, and the thread-local variable can also be restored.

The thread can include a kernel-level thread and a user-level thread. The kernel-level thread can be a thread that can be perceived by the kernel. Currently, a mainstream operating system can directly support a thread at a kernel level, and a mainstream thread library also performs encapsulation based on the kernel-level thread. In one or more embodiments of this application, a thread provided by the mainstream thread library is also referred to as a standard thread. The user-level thread can be a thread that is not perceived by the kernel. The operating system does not learn of existence of the user-level thread, and the user-level thread is created completely in the user space.

Compared with the kernel-level thread, the user-level thread has the following two advantages. Advantage 1: Different programs can customize respective dedicated scheduling policies. Advantage 2: Thread switching costs are small. The following describes the two advantages.

Scheduling of the kernel-level thread is usually implemented by the operating system. For example, scheduling of the kernel-level thread can be implemented by using a thread scheduling program provided by the operating system. Usually, a scheduling policy of the kernel-level thread cannot be modified by a user. Therefore, scheduling of the kernel-level thread usually cannot satisfy an actual scheduling need of the user.

The user-level thread can be controlled by the user, and the user can implement a special scheduling need or scheduling policy based on an actual need of the user. In some embodiments, the user can customize priorities of different threads, or the user can perform CPU isolation and control for different thread groups.

In some other embodiments, the user can improve performance by controlling the scheduling policy. For example, the user can properly formulate the scheduling policy to improve CPU utilization. For example, the thread can have various dependencies, and common dependencies include a producer (for example, a CPU) and a consumer (for example, a thread). If a scheduling opportunity of the producer is insufficient, a large quantity of consumers may be in a waiting state, and a CPU of the system cannot be fully used. Therefore, the scheduling policy can be adjusted through the user-level thread, to improve CPU utilization. For another example, the user can control an execution sequence of different threads to control local access of code and data, to improve utilization of a data cache and an instruction cache.

In addition, switching of the user-level thread does not relate to the system call shown in FIG. 1. Therefore, switching between the user mode and the kernel mode can be reduced for the user-level thread, to reduce thread switching overheads.

Currently, the user-level thread is mainly implemented by a coroutine. The coroutine is a lightweight thread. Although the coroutine has the above-mentioned various advantages of the user-level thread, compared with a mainstream kernel-level thread (also referred to as a standard thread below), the coroutine lacks some functions, and has poor compatibility. For example, the coroutine does not support the thread-local variable, cannot implement preemptive scheduling, and does not support signal communication. In particular, when a code library is too large or there is an uncontrollable source code library, a dependency on the above-mentioned features cannot be avoided, and a coroutine solution cannot be used.

For the thread-local variable, as described above, the standard thread can maintain a segment register, and the operating system can access the thread-local variable through the segment register. However, to implement lightweightness, a current coroutine does not have a segment register used to maintain the thread-local variable. Consequently, the coroutine does not support the thread-local variable, and has poor compatibility with the standard thread.

For preemptive scheduling, the coroutine mainly implements thread switching or scheduling by running a thread based on written code. Currently, thread scheduling cannot be implemented through preemption.

For signal communication, because the coroutine is a user-level thread and a thread identity (ID) needs kernel support, the coroutine has no thread ID. Because there is no thread ID, the coroutine cannot receive a signal, and signal communication cannot be implemented.

In view of this, to resolve one or more of the above-mentioned problems, one or more embodiments of this disclosure provide a thread management method. A context of the kernel-level thread includes various types of information of the kernel-level thread. Therefore, in the one or more embodiments of this disclosure, the user-level thread inherits the context of the kernel-level thread, so that the user-level thread can have various functions of the kernel-level thread, to improve compatibility between the user-level thread and the kernel-level thread.

FIG. 2 is a schematic flowchart illustrating a thread management method, according to one or more embodiments of this disclosure. As shown in FIG. 2, the management thread method can include step S210 to step S240. The method in the one or more embodiments of this application can be performed by an operating system. The operating system can be any type of operating system. This is not limited in the one or more embodiments of this application. For example, the operating system can be a Linux operating system or a Windows operating system.

In step S210, a first thread is created. The first thread can be a kernel-level thread (for example, pthread). The kernel-level thread can be, for example, a thread created through an API provided by a kernel-level thread library.

The first thread has a first thread context. After the first thread is created, the first thread context can be initialized. The first thread context can be, for example, jmp ctx. The first thread context can include one or more of the following information: a plurality of registers and a running stack. The register can include one or more of the following: an instruction pointer register, a stack pointer register, and values of a plurality of segment registers. In some embodiments, the first thread context can include a thread-local variable of the first thread. The thread-local variable can be indicated by the value of the segment register.

In step S120, a second thread is created through the first thread. The second thread is a user-level thread (for example, uthread), and the second thread inherits the first thread context.

That the second thread inherits the first thread context can mean that the first thread context is stored in a second thread context, so that the second thread inherits a state of the first thread. For example, each register of the first thread can be stored in the second thread context. The second thread inherits the first thread context, so that the second thread inherits a running environment of the first thread (most importantly, inherits an instruction location of the first thread), to improve compatibility of the second thread.

In the one or more embodiments of this application, one user-level thread can correspond to one kernel-level thread, or the user-level thread and the kernel-level thread are in a one-to-one correspondence. If a plurality of user-level threads need to be created, a plurality of kernel-level threads that are in a one-to-one correspondence with the plurality of user-level threads also need to be created.

In step S130, after the second thread is stored in a run queue, the first thread is controlled to enter an idle loop state.

A user-level thread in a runnable state (for example, a user-level thread in a TASK_RUNNING state) can be stored in the run queue. After the second thread is in the runnable state, the second thread is stored in the run queue, to wait to be scheduled for execution.

The idle loop state is a state in which the operating system performs no scheduling. After the first thread enters the idle loop state, the operating system considers that the first thread is in a sleep state and does not need to be executed. Therefore, the operating system does not actively invoke the first thread. The first thread is set to be in the idle loop state, so that the second thread can fully use various resources of the first thread without conflicting with the first thread.

In step S140, the second thread is selected from the run queue through a scheduling thread, and the second thread is executed.

The scheduling thread is a kernel-level thread. The scheduling thread can implement scheduling of the user-level thread. The scheduling thread can select the user-level thread from the run queue based on a specific scheduling policy, and execute the selected user-level thread.

In addition, as described above, preemptive scheduling cannot be implemented in a current user-level thread solution. Preemptive scheduling can be understood as interrupting a second thread currently being executed, and executing another thread, so that the another thread can preempt scheduling of the second thread. Therefore, preemptive scheduling of a thread is mainly interrupting a thread currently being executed. In consideration that the second thread in the one or more embodiments of this disclosure is executed by the scheduling thread, the second thread can be interrupted by interrupting the scheduling thread. Because the scheduling thread is a kernel-level thread, and the kernel-level thread has a thread ID, the scheduling thread can receive a signal. Based on this, in the one or more embodiments of this disclosure, a special signal can be sent to the scheduling thread, so that the second thread is interrupted through the scheduling thread. In addition, because the special signal is sent to the scheduling thread, the special signal does not conflict with a signal sent to the user-level thread or the kernel-level thread, to reduce a signal conflict.

In some embodiments, a first signal can be received through the scheduling thread. In response to the first signal, execution of the second thread is stopped through the scheduling thread. After receiving the first signal, the scheduling thread can interrupt execution of the second thread. Further, the scheduling thread can select a next user-level thread from the run queue and execute the next user-level thread. Certainly, to ensure that the second thread can continue to be executed, the second thread can be re-stored in the run queue, to wait to be scheduled for a next time.

In the one or more embodiments of this application, execution of the second thread can be interrupted after an execution time of the second thread exceeds a preset threshold. For example, the first signal is sent to the scheduling thread after the execution time of the second thread exceeds the preset threshold.

The first signal can be triggered by a timer. In the one or more embodiments of this disclosure, the timer can be maintained, and after the timer expires, generation of the first signal can be triggered. After switching to a new user-level thread is performed each time, the timer can perform timing again. In this way, each user-level thread can be executed for equal duration each time, to avoid a problem that another thread cannot be processed in a timely manner because one thread occupies a processing resource for a long time.

The first signal can be performed through a signal processing thread. After receiving the first signal, the signal processing thread can store a register state of the second thread in the second thread context, and the second thread is re-stored in the run queue, to wait to be scheduled for a next time.

The one or more embodiments of this disclosure provide a solution to a problem that the user-level thread cannot implement signal communication. Each user-level thread corresponds to one kernel-level thread. Therefore, in the one or more embodiments of this disclosure, the kernel-level thread can be used to receive a signal. Although the first thread is in the idle loop state, the first thread can normally receive a signal. In other words, the signal can be normally sent to the first thread. In addition, a signal mask of the first thread can also be set normally. For example, specific signals to which the first thread can respond and specific signals to which the first thread does not respond are set.

Based on this, in the one or more embodiments of this disclosure, a second signal can be received by the first thread. In response to the second signal, the second thread can be marked to be in a signal interrupt state. The scheduling thread does not execute a thread that is marked to be in the signal interrupt state. Therefore, after the second thread is marked to be in the signal interrupt state, the scheduling thread does not execute the second thread.

After the second signal is received, the second signal can be processed by the signal processing thread. The second signal can be associated with a function registered by a user, and processing of the second signal can be performing the function. Before the signal processing thread processes the second signal, the second thread needs to be marked to be in the signal interrupt state. After the second thread is marked to be in the signal interrupt state, the signal processing thread can process the second signal.

The second signal can be sent to a kernel-level thread corresponding to any user-level thread. For example, the second signal can be sent to a kernel-level thread corresponding to the user-level thread that is being executed. For another example, the second signal can be sent to a kernel-level thread corresponding to a to-be-scheduled user-level thread (a user-level thread that is not executed currently) in the run queue.

If the second signal is being executed, the operating system marks the second thread to be in the signal interrupt state, but the second thread is still in an execution state. In this case, in the one or more embodiments of this disclosure, whether the second thread is in an execution state can be further determined after the second thread is marked to be in the signal interrupt state. Execution of the second thread is interrupted if the second thread is in the execution state. After execution of the second thread is interrupted, the second signal is processed by the signal processing thread, so that correctness of a signal function can be ensured.

The second thread can be interrupted in the above-mentioned preemptive scheduling manner. For example, the first signal can be sent to the scheduling thread, so that the scheduling thread interrupts execution of the second thread.

After the signal processing thread completes processing of the second signal, the signal interrupt state of the second thread can be cleared, so that the second thread can continue to be executed.

After running of the second thread is completed, the first thread can inherit the second thread context. For example, context information of the second thread can be stored in the first thread context. In some embodiments, after running of the second thread ends, the scheduling thread can notify the first thread to exit the idle loop state. The scheduling thread can notify the first thread in any inter-thread communication method. For example, the scheduling thread can notify the first thread by using a pthread_cond_signal( ) signal. After the first thread exits the idle loop state, the first thread can inherit the second thread context, to complete end work of a thread, for example, release a system resource or a process resource. Specifically, information such as memory occupied by a thread return value, a thread stack, and a register state can be released.

With reference to FIG. 4 to FIG. 6, the following provides specific examples of one or more embodiments of this disclosure. It is worthwhile to note that the following examples are merely intended to help a person skilled in the art understand the embodiments of this application, and are not intended to limit the embodiments of this application to the illustrated protocols or specific scenarios. A person skilled in the art can clearly perform various equivalent modifications or changes based on the following examples. Such modifications or changes also fall within the scope of the embodiments of this application.

FIG. 4 is a schematic flowchart illustrating that a first thread enters an idle loop state. The first thread can enter the idle cyclic state based on a special function. This special function is used to execute a procedure shown in FIG. 4.

As shown in FIG. 4, in step S410, a second thread is allocated and initialized.

In step S420, a CPU register is stored in a second thread context.

In step S430, memory is allocated as a stack used in an idle loop of the first thread.

In step S440, the first thread jumps to the stack, and prepares to enter the idle loop state.

In step S450, the first thread stores the second thread in the run queue.

In step S460, the first thread enters the idle loop state.

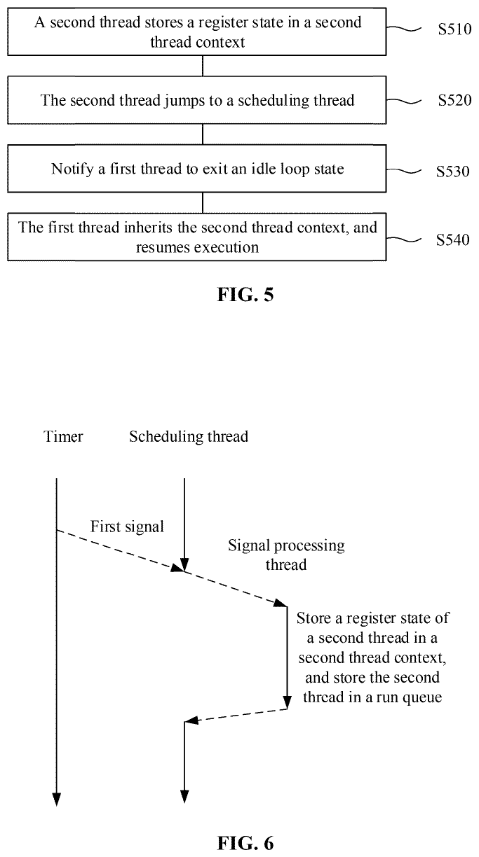

After running of the second thread ends, the second thread can return to the scheduling thread based on a special function. The scheduling thread notifies the second thread to exit the idle loop state, and the second thread inherits a state of the first thread and then continues to be executed. With reference to FIG. 5, the following describes a subsequent operation procedure of the first thread and the second thread after running of the second thread ends.

As shown in FIG. 5, in step S510, the second thread stores a register state in the second thread context.

In step S520, the second thread jumps to the scheduling thread.

In step S530, the scheduling thread can notify, in an inter-thread communication method (for example, pthread_cond_signal( ), the first thread to exit the idle loop state.

In step S540, after exiting the idle loop state, the first thread inherits the second thread context and resumes execution.

With reference to FIG. 6, the following describes a preemptive scheduling process of the user-level thread.

A timer triggers generation of the first signal, and sends the first signal to the scheduling thread.

After receiving the first signal, the scheduling thread can interrupt execution of the second thread. Optionally, the register state can be stored in the second thread context in the signal processing thread, to be used in a next time of scheduling. Further, the second thread can be re-stored in the run queue, to wait to be scheduled for a next time.

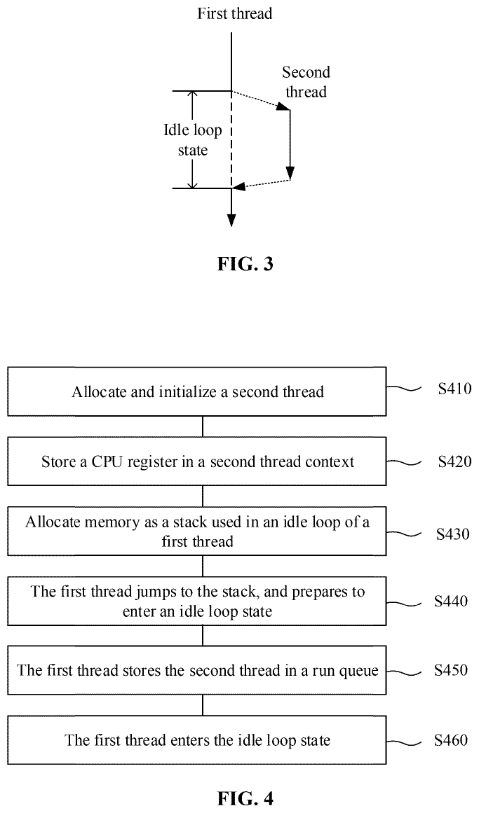

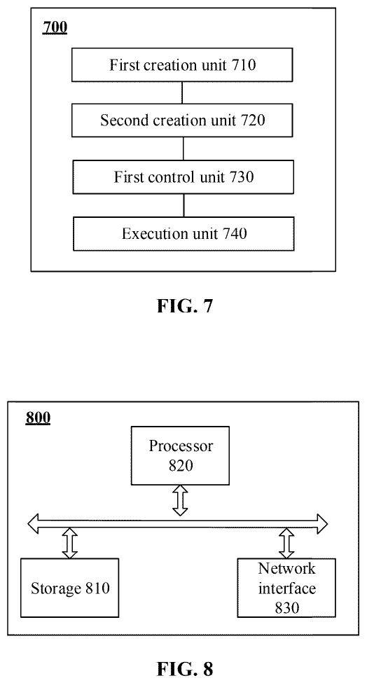

The method embodiments of this disclosure are described above in detail with reference to FIG. 1 to FIG. 6. The following describes apparatus embodiments of this disclosure in detail with reference to FIG. 7 to FIG. 8. It should be understood that descriptions of the method embodiments correspond to descriptions of the apparatus embodiments. Therefore, for a part that is not described in detail, references can be made to the method embodiments.

FIG. 7 is a schematic structural diagram illustrating a thread management apparatus, according to one or more embodiments of this disclosure. The apparatus 700 can include a first creation unit 710, a second creation unit 720, a first control unit 730, and an execution unit 740.

The first creation unit 710 is configured to create a first thread. The first thread is a kernel-level thread, and the first thread has a first thread context.

The second creation unit 720 is configured to create a second thread through the first thread. The second thread is a user-level thread, and the second thread inherits the first thread context.

The first control unit 730 is configured to: after the second thread is stored in a run queue, control the first thread to enter an idle loop state.

The execution unit 740 is configured to: select the second thread from the run queue through a scheduling thread, and execute the second thread.

Optionally, in some possible implementations, the apparatus 700 further includes: a first receiving unit, configured to receive a first signal through the scheduling thread; a second control unit, configured to: in response to the first signal, control, through the scheduling thread, the second thread to stop being executed; and a storage unit, configured to re-store the second thread in the run queue.

Optionally, in some possible implementations, the first signal is triggered by a timer.

Optionally, in some possible implementations, the apparatus further includes: a second receiving unit, configured to receive a second signal through the first thread; a marking unit, configured to: in response to the second signal, mark the second thread to be in a signal interrupt state; and a processing unit, configured to process the second signal through a signal processing thread.

Optionally, in some possible implementations, after the marking the second thread to be in a signal interrupt state, the apparatus further includes: a determining unit, configured to determine whether the second thread is in an execution state; and an interrupt unit, configured to interrupt execution of the second thread if the second thread is in the execution state.

Optionally, in some possible implementations, the first thread context includes a thread-local variable of the first thread.

FIG. 8 is a schematic structural diagram illustrating a thread management apparatus, according to one or more other embodiments of this disclosure. The apparatus 800 can be an apparatus with a computing function. The apparatus can be an electronic device on which an operating system is installed. The apparatus 800 may include a memory 810 and a processor 820. The memory 810 can be configured to store executable code. The processor 820 can be configured to execute the executable code stored in the memory 810, to implement the steps in the methods described above. In some embodiments, the apparatus 800 can further include a network interface 830, and data exchange between the processor 820 and an external device can be implemented through the network interface 530.

It should be understood that, in the one or more embodiments of this disclosure, the processor can be a central processing unit (CPU), and the processor can be another general-purpose processor, a digital signal processor (DSP), an application-specific integrated circuit (ASIC), a field programmable gate array (FPGA) or another programmable logic device, a discrete gate or transistor logic device, a discrete hardware component, etc. The general-purpose processor can be a microprocessor, or the processor can be any conventional processor, etc.

It should be understood that in this embodiment of this disclosure, “B corresponding to A” indicates that B is associated with A, and B can be determined based on A. However, it should be further understood that determining B based on A does not mean that B is determined based on only A, and B can be further determined based on A and/or other information.

It should be understood that the term “and/or” in this specification describes only an association relationship for describing associated objects and represents that three relationships can exist. For example, A and/or B can represent the following three cases: Only A exists, both A and B exist, and only B exists. In addition, the character “/” in this specification usually indicates an “or” relationship between the associated objects.

It should be understood that sequence numbers of the above-mentioned processes do not mean execution sequences in various embodiments of this disclosure. The execution sequences of the processes should be determined based on functions and internal logic of the processes, and should not be construed as any limitation on the implementation processes of embodiments of this disclosure.

In the several embodiments provided in this disclosure, it should be understood that the disclosed system, apparatus, and method can be implemented in other manners. For example, the described apparatus embodiments are merely examples. For example, division into the units is merely logical function division and can be other division in actual implementations. For example, a plurality of units or components may be combined or integrated into another system, or some features may be ignored or not performed. In addition, the displayed or discussed mutual couplings or direct couplings or communication connections can be implemented through some interfaces. The indirect couplings or communication connections between the apparatuses or units can be implemented in an electrical form, a mechanical form, or another form.

The units described as separate parts can be or do not have to be physically separated, and parts displayed as units can be or do not have to be physical units, that is, can be located in the same place or can be distributed to a plurality of network units. Some or all of the units can be selected based on actual demands to achieve the objectives of the solutions in the embodiments.

In addition, functional units in the embodiments of this disclosure can be integrated into one processing unit, each of the units can exist alone physically, or two or more units are integrated into one unit.

All or some of the previous embodiments can be implemented by software, hardware, firmware, or any combination thereof. When software is used for implementation, the embodiments can be entirely or partially implemented in a form of a computer program product. The computer program product includes one or more computer program instructions. When the computer program instructions are loaded and executed on the computer, the procedure or functions according to embodiments of this disclosure are all or partially generated. The computer can be a general-purpose computer, a dedicated computer, a computer network, or another programmable apparatus. The computer instructions can be stored in a computer-readable storage medium, or can be transmitted from a computer-readable storage medium to another computer-readable storage medium. For example, the computer instructions can be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium can be any usable medium accessible by the computer, or a data storage device, for example, a server or a data center, integrating one or more usable media. The usable medium can be a magnetic medium (for example, a floppy disk, a hard disk, or a magnetic tape), an optical medium (for example, a digital video disc (DVD)), a semiconductor medium (for example, a solid state drive (SSD)), etc.

The above-mentioned descriptions are merely specific implementations of this disclosure, but the protection scope of this disclosure is not limited thereto. Any variation or replacement readily figured out by a person skilled in the art within the technical scope disclosed in this disclosure shall fall within the protection scope of this disclosure. Therefore, the protection scope of this disclosure shall be subject to the protection scope of the claims.

What is claimed is:

1. A computer-implemented method for thread management, comprising:
creating a first thread, wherein the first thread is a kernel-level thread, and the first thread has a first thread context;
creating a second thread through the first thread, wherein the second thread is a user-level thread, and the second thread inherits the first thread context;
after the second thread is stored in a run queue, controlling the first thread to enter an idle loop state; and
selecting the second thread from the run queue through a scheduling thread, and executing the second thread.

2. The computer-implemented method of claim 1, comprising:
receiving a first signal through the scheduling thread;
in response to the first signal, controlling, through the scheduling thread, the second thread to stop being executed; and
re-storing the second thread in the run queue.

3. The computer-implemented method of claim 2, wherein the first signal is triggered by a timer.

4. The computer-implemented method of claim 1, comprising:
receiving a second signal through the first thread;
in response to the second signal, marking the second thread to be in a signal interrupt state; and
processing the second signal through a signal processing thread.

5. The computer-implemented method of claim 4, wherein, after the marking, the second thread to be in a signal interrupt state.

6. The computer-implemented method of claim 5, comprising:
determining whether the second thread is in an execution state; and
interrupting execution of the second thread if the second thread is in the execution state.

7. The computer-implemented method of claim 1, wherein the first thread context comprises a thread-local variable of the first thread.

8. A non-transitory, computer-readable medium storing one or more instructions executable by a computer system to perform one or more operations, comprising:
creating a first thread, wherein the first thread is a kernel-level thread, and the first thread has a first thread context;
creating a second thread through the first thread, wherein the second thread is a user-level thread, and the second thread inherits the first thread context;
after the second thread is stored in a run queue, controlling the first thread to enter an idle loop state; and
selecting the second thread from the run queue through a scheduling thread, and executing the second thread.

9. The non-transitory, computer-readable medium of claim 8, comprising:
receiving a first signal through the scheduling thread;
in response to the first signal, controlling, through the scheduling thread, the second thread to stop being executed; and
re-storing the second thread in the run queue.

10. The non-transitory, computer-readable medium of claim 9, wherein the first signal is triggered by a timer.

11. The non-transitory, computer-readable medium of claim 8, comprising:
receiving a second signal through the first thread;
in response to the second signal, marking the second thread to be in a signal interrupt state; and
processing the second signal through a signal processing thread.

12. The non-transitory, computer-readable medium of claim 11, wherein, after the marking, the second thread to be in a signal interrupt state.

13. The non-transitory, computer-readable medium of claim 12, comprising:
determining whether the second thread is in an execution state; and
interrupting execution of the second thread if the second thread is in the execution state.

14. The non-transitory, computer-readable medium of claim 8, wherein the first thread context comprises a thread-local variable of the first thread.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
creating a first thread, wherein the first thread is a kernel-level thread, and the first thread has a first thread context;
creating a second thread through the first thread, wherein the second thread is a user-level thread, and the second thread inherits the first thread context;
after the second thread is stored in a run queue, controlling the first thread to enter an idle loop state; and
selecting the second thread from the run queue through a scheduling thread, and executing the second thread.

16. The computer-implemented system of claim 15, comprising:
receiving a first signal through the scheduling thread;
in response to the first signal, controlling, through the scheduling thread, the second thread to stop being executed; and
re-storing the second thread in the run queue.

17. The computer-implemented system of claim 16, wherein the first signal is triggered by a timer.

18. The computer-implemented system of claim 15, comprising:
receiving a second signal through the first thread;
in response to the second signal, marking the second thread to be in a signal interrupt state; and
processing the second signal through a signal processing thread.

19. The computer-implemented system of claim 18, wherein, after the marking, the second thread to be in a signal interrupt state.

20. The computer-implemented system of claim 19, comprising:
determining whether the second thread is in an execution state; and
interrupting execution of the second thread if the second thread is in the execution state.
